(19) United States
(12) Patent Application Publication
(10) Pub. No.: US 2007/0282503 A1
(43) Pub. Date: Dec. 6, 2007

(54) Parking Assistance

(75) Inventor: Stefan Luke, Olpe (DE)

Correspondence Address: Gerlinde Nattler;Continental Teves Inc, One Continental Drive, Auburn Hills, MI, 48326, US

(73) Assignee: Continental Teves AG & CO.oHG

(21) Appl. No.: 10/591,235

(22) PCT Filed: Feb. 25, 2005
(86) PCT No.: PCT/EP05/50821

§ 371 Date: Jun. 22, 2007

(30) Foreign Application Priority Data
Mar. 5, 2004 (DE) 102004011408.0
Feb. 16, 2005 (DE) 102005006966.5

(51) Int. Cl. B62D 6/00

(52) U.S. Cl. 701/44

(57) ABSTRACT

Disclosed is a parking assistance for a vehicle. In autonomous parking on a path for parking the vehicle, the driver of the vehicle is assisted in a parking maneuver on the path for parking the vehicle by a steering torque applied to the steering wheel. The driver is guided on the path for parking the vehicle by one or two artificial steering stops and the path for parking the vehicle is divided into a maneuvering path in the area of a parking space and an approach path situated prior to the maneuvering path in accordance with the starting position of the vehicle.

### BACKGROUND OF THE INVENTION

The invention relates to a parking assistance for a vehicle.

The invention also relates to a navigation module for a vehicle.

The invention also relates to a method for parking for a vehicle.

Known parking assistance systems work with navigation for the parking operation based on stored data records for various parking space lengths. These methods use up a great deal of memory capacity.

Other methods of navigation for parking are performed with a calculation from a [sic; end of paragraph]

In addition, parking operations are possible by navigation based on given geometric formulas such as the circle, line or clothoid path. These navigation methods are relatively computation-intensive and usually result in inconvenient parking paths.

The object of this invention is to create a parking assistance system that will permit automatic guidance of the vehicle or supportive guidance for the driver in a relatively simple and convenient manner.

### SUMMARY OF THE INVENTION

This object is achieved by a parking assistance system for a motor vehicle, which is characterized in that the parking assistance permits autonomous driving or steering of the vehicle on a path for parking or a driver of the vehicle in a parking operation on the path for parking the vehicle by means of a steering moment applied to the steering wheel whereby the driver is guided on the path assisting the driver of the vehicle by at least one artificial steering stop, preferably one or two artificial steering stops, and the path for parking the vehicle is divided into a maneuvering path in the area of the parking space and an approach path prior to the maneuvering path.

In an embodiment according to this invention, convenient instructions are given to the driver by means of haptic feedback. This ensures that the driver will or will intentionally concur with these instructions during the parking operation.

In an alternative embodiment according to this invention, the vehicle is automatically guided into a parking space on a certain path.

According to this invention, the navigation is divided into a reliable maneuvering path in the critical area of the parking space and a convenient approach path.

This object is achieved by a navigation module for a vehicle, in particular for a parking assistance according to the invention, said navigation module being characterized in that the path for parking the vehicle is divided into a maneuvering path in the area of a parking space and an approach path prior to the maneuvering path.

This object is also achieved by a method for parking a vehicle which is characterized in that the method permits autonomic driving or steering of the vehicle on a path for parking or assists the driver of the vehicle in a parking maneuver in which a steering torque is applied to the steering wheel and at least one artificial steering stop, preferably one or two artificial steering stops are generated and in which the driver is guided by the artificial steering stop on the path for parking the vehicle, and the path for parking the vehicle is divided into a maneuvering path in the area of a parking space and an approach path prior to the maneuvering path.

A reduction in computation expense can be achieved according to this invention by stretching a path calculated for the minimal parking space.

According to this invention at least a partial area of the approach path is determined on the basis of one or more polynomials, preferably 2 to 3 polynomials.

According to this invention a starting point of the approach path to the parking path, determined on the basis of at least one polynomial, is determined as a function of the position of the vehicle to be parked.

According to this invention a starting point of the approach path determined on the basis of the at least one polynomial is determined, this approach point lying on the path for parking the vehicle on a circular path or a clothoid path situated in front of it depending on the starting position of the vehicle.

According to this invention, the maneuvering path is formed from an arc of a circle.

According to this invention, the arc of the circle which normally makes it possible to pass the corners is shortened, with the length of the arc of the circle being selected so that the front right corner of a vehicle to be parked in reverse just passes left rear corner of an object bordering the parking space at the front.

The starting point to the parking path is preferably selected for vehicles that are at a great distance from the parking space and are to be parked at a flat angle to the parking space, so that the starting point is close to the turning point because an elongated approach path entails a direct route and only a short maneuvering into the opposite driving path.

However, the starting point to the parking path is set late on the clothoid path or directly on the circular path for vehicles close to the parking space or to be parked at a steep angle to the maneuvering path to maintain the largest possible starting area for the parking operation and avoid unnecessary steering maneuvers.

The starting point may be selected in discrete increments or continuously on the clothoid path for cases between the two conditions mentioned above, in which case the length of the arc of the circle is selected so that the front right corner of a vehicle to be parked in reverse just passes the left rear corner of an object bordering the parking space for the front.

According to this invention, at least one clothoid path is attached to the circle, reducing deflection into the opposing path of travel, on the arc of the circle before the turning point (in the direction of the maneuvering path).

According to this invention, the path for the smallest possible parking space is adapted to the real parking space by segments.

The navigation for parking backwards is preferably provided, the path being planned according to data regarding the parking space in relation to the vehicle and the path of the vehicle into the parking space.

The invention will now be explained in greater detail on the basis of two figures (FIG. 1 and FIG. 2) below as an example.

### BRIEF DESCRIPTION OF THE DRAWINGS

In the figures:

FIG. 1 shows the known path of a parking maneuver as a series of two arcs of circles.

FIG. 2 shows the path of a parking maneuver according to this invention by a series of an arc of a circle and a path based on a polynomial.

### DETAILED DESCRIPTION OF THE DRAWINGS

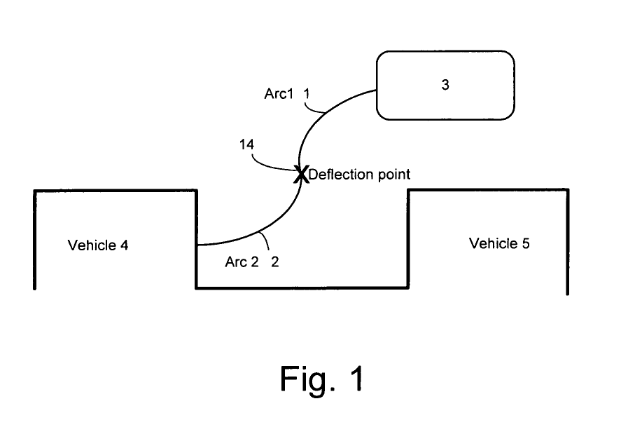

The alignment of two arcs 1, 2 about a turning point 14 as illustrated in FIG. 1 allows the vehicle 3 to be parked in the smallest possible parking space 6 between a vehicle 4 and a vehicle 5.

However, this path requires stopping the vehicle 3 at the turning point 14. In addition, steering and vehicle are under a great load.

According to this invention, various possible paths in the parking maneuver are evaluated with regard to different factors. In particular paths that are taken into account are those requiring a short length of the smallest possible parking space, a short maneuvering of the front of the vehicle into the opposing path of travel, a low required change in steering angle, a low maximum required steering angle and a low computation expense for a driving path.

Taking these factors into account, a combination of an arc of a circle after the turning point and the insertion of a double clothoid path according to this invention constitutes an improvement of the path. This permits a steady course of the steering angle. In addition, a clothoid arc may be inserted at the beginning of the arc 1 (see FIG. 1) in the direction of the vehicle 3 being maneuvered to adapt the curvature of the path at the endpoint to the yaw angle of the vehicle.

This approach connects a limited change in steering angle with a minimal maneuvering into the opposing driving path under these circumstances and achieving minimal parking spaces. Furthermore, it requires a low computation expense because the path need not be checked for collision.

A change in steering angle that is even more acceptable to the driver is achieved according to this invention by calculating the path by using a fifth order polynomial:
y=f(x)=a₀x⁰+a₁x¹+a₂x²+a₃x³+a₄x⁴+a₅x⁵ (1)
where the individual coefficients are determined from the following secondary conditions:

$$f ( {x}_{0} ) {\vert}_{arcofcircle} = {y}_{0} \\ {f ( {x}_{0} )}^{′} {\vert}_{arcofcircle} = \frac{ⅆ y}{ⅆ x} {\vert}_{arcofcircle} \\ {f ( {x}_{0} )}^{″} {\vert}_{arcofcircle} = \frac{{ⅆ}^{2} y}{ⅆ {x}^{2}} {\vert}_{arofcircle} \\ f ( {x}_{1} ) {\vert}_{vehicle} = {y}_{1} \\ {f ( {x}_{1} )}^{′} {\vert}_{vehicle} = \frac{ⅆ y}{ⅆ x} {\vert}_{vehicle} \\ {f ( {x}_{1} )}^{″} {\vert}_{vehicle} = \frac{{ⅆ}^{2} y}{ⅆ {x}^{2}} {\vert}_{vehicle} \qquad ( 2 )$$

These secondary conditions are selected so that smooth steering at the transitions is made possible.

If the polynomial is used to calculate the complete parking space, this still does not always ensure that the vehicle to be parked will pass by the front corner of vehicle 5 without colliding with it.

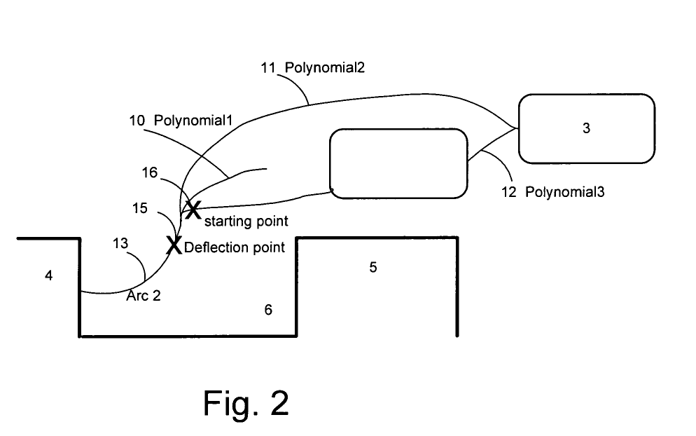

Taking into account the aforementioned factors, the approach depicted in FIG. 2 is made possible in particular, namely the approach with a combination of an arc 13 after the deflection point 15, which permits reliable maneuvering of the vehicle 3 into the parking space 6 between two vehicles 4, 5 and driving the vehicle on this arc 13 through a polynomial that is aligned at a starting point such as a starting point 16 on the arc.

There is no danger of the vehicle having a collision in the parking space 6 if it follows the path.

If the vehicle is a very great distance away from the parking space, a polynomial might lead too far into the opposing driving path or to a path that forces a lateral stop at the front of the vehicle.

If the vehicle has driven very far past the parking space, there is the risk that a polynomial that extends far into the opposing path may be calculated. Then according to this invention, a clothoid path is to be attached to the arc of the circle, thereby reducing such deflection.

The starting point of the polynomial and the collision-proof parking trajectory (path) is in this case a function of the standing point of the vehicle 3 but at the latest on the arc 13 at the deflection point 15, resulting in paths like 10, 11 or 12, depending on which is used.

In an alternative possibility for avoiding too great a maneuver into the opposing path with parking spaces at a greater distance, provisions are allowed for shortening the arc. The length of the arc here is selected so that the front right corner of the vehicle 3 to be parked just passes by the rear left corner of the vehicle 5. This approach has the advantage that the steering movement is much more convenient. However it requires a check on the boundary conditions to ascertain whether the planned path is drivable and whether optionally a new plan with a less shortened arc is necessary.

To minimize computation expense, the method only determines the polynomial relatively between vehicle 3 and starting point 13 on the arc of the circle. To do so, the arc of the circle is stored only for the smallest possible parking space. The length of the arc of the circle is selected so that the front right corner of the vehicle 3 to be parked just passes by the left rear corner of the vehicle 5. This method has the advantage that it greatly simplifies checking on the boundary conditions, i.e., whether the planned path is drivable.

According to this invention, a check is performed to determine whether the right corner of the vehicle 3 being parked will collide with vehicle 5, whether the left corners of the vehicle 3 being parked come into the opposing driving path, whether the maximum steering angle is exceeded and whether the maximum steering angle speed [sic; steering angle] is exceeded.

These checks are performed either approximately using simple mathematical basic operations with the addition of safety margins or accurate calculations are performed with the addition of trigonometric functions or by analyzing an engine characteristics map, depending on the available hardware and computing power in the vehicle.

Since only the path described by the polynomial need be tested, certain operations (e.g., determination of the first and second derivations) may already be solved symbolically in advance.

In ascertaining drivability by analyzing an engine characteristics map, the input data used includes the vehicle position, the vehicle yaw angle and the vehicle steering angle, based on the minimum possible parking space. With these four inputs, it is possible to determine from the engine characteristics map whether safe parking is possible. The engine characteristics map is calculated in advance (offline) and is available in fixed form in a memory in the control unit. Based on scalability, the information obtained in this way is used for parking spaces of any size.

To further reduce the computation expense, the method determines only the polynomial relatively between the vehicle and the starting point on the fixed parking trajectory (parking path). This is then stored only for the smallest possible parking space.

If the available parking space is larger than the minimum possible parking space, then a scaling factor is determined in y direction based on the smallest possible parking space. This is done in such a way that the minimum distance between the front right corner of the vehicle 3 being parked and the left rear corner of the vehicle 5 is always constant.

Then the fixedly stored standard arc of the circle is scaled in y direction using this factor and connected to the vehicle via a polynomial.

Thus the maximum steering angle and the change in steering angle are reduced while at the same time the certainty that the vehicle will not collide in driving the path is retained.

1-11. (canceled)

12. A parking assistance device for a vehicle comprising:
a parking assistance unit that permits autonomous parking or steering of the vehicle on a path for parking or assists a driver of the vehicle in a parking operation on the path for parking the vehicle by applying a steering torque to a steering wheel, wherein the driver is guided by at least one artificial steering stop on the path for parking the vehicle, and the path for parking the vehicle is divided into an initial maneuvering path in the area of a parking space and an approach path prior to the maneuvering path.

13. A device according to claim 12, wherein the path for parking the vehicle is divided into a maneuvering path in the area of a parking space and an approach path situated before the maneuvering path.

14. A method for parking a vehicle that permits autonomous driving or steering of a vehicle on a path for parking or assists a driver of the vehicle in a parking operation, the method comprising:
applying a steering torque to a steering wheel;
generating at least one artificial steering stop; and
dividing a path for parking the vehicle into a maneuvering path in an area of a parking space and an approach path prior to the maneuvering path, wherein the driver is guided by the artificial steering stop on the path for parking the vehicle.

15. A method according to claim 14, wherein at least one partial area of the approach path is ascertained on the basis of one or more polynomials.

16. A device according to claim 15, wherein a starting point of the approach path to the maneuvering path ascertained on the basis of at least one polynomial is ascertained as a function of a position of the vehicle to be parked.

17. A method according to claim 14, wherein a starting point of the approach path ascertained on the basis of at least one polynomial is ascertained, said approach point being situated on the path for parking the vehicle, depending on a starting position on a circular path or a clothoid path prior thereto.

18. A method according to claim 14, wherein the maneuvering path is formed by an arc of a circle.

19. A method according to claim 18, wherein the arc of the circle which normally allows passing the corners is shortened, whereby the length of the arc of the circle is selected so that the front right corner of a vehicle being parked in reverse just passes by the left rear corner of an object bordering the parking space at the front.

20. A method according to claim 18, wherein at least one clothoid path is added to the circle, which reduces deflection into the opposing driving path, and does so on the arc of the circle prior to the deflection point.

21. A method according to claim 14, wherein a path for a smallest possible parking space is adapted to an actual parking space by segments.

22. A method according to claim 14, wherein navigation is provided for parking in reverse, said navigation being planned according to information about the parking space in relation to the vehicle and the path of the vehicle into the parking space.
